(19) United States
(12) Patent Application Publication
(10) Pub. No.: US 2024/0416481 A1
(43) Pub. Date: Dec. 19, 2024

(54) CUTTING TOOL

(71) Applicant: Nanjing Chervon Industry Co., Ltd., Nanjing (CN)

(72) Inventors: Kai Qi, Nanjing (CN); Pan Lin, Nanjing (CN); Jun Le, Nanjing (CN)

(21) Appl. No.: 18/820,551

(22) Filed: Aug. 30, 2024

Related U.S. Application Data
(63) Continuation of application No. PCT/CN2023/125999, filed on Oct. 23, 2023.

(30) Foreign Application Priority Data
Nov. 16, 2022 (CN) 202211461129.3
Nov. 16, 2022 (CN) 202223044861.9

(51) Int. Cl. B24B 49/10; B25F 5/02

(52) U.S. Cl. CPC B24B 49/10; B25F 5/02

(57) ABSTRACT

A cutting tool includes a housing, a battery pack coupling portion, an electric motor, a control board, a control unit, and a display assembly. The battery pack coupling portion is configured to be connected to a battery pack for powering the cutting tool. The electric motor can drive a working accessory to rotate and is electrically connected to the control board. The cutting tool further includes a display mechanism. The display mechanism includes the control unit and the display assembly. The control unit is electrically connected to the control board. The display assembly is electrically connected to the control unit. When the control unit transmits an electrical signal to the display assembly, the display assembly displays a rotation direction of the electric motor or other information.

This application is a continuation of International Application Number PCT/CN2023/125999, filed on Oct. 23, 2023, through which this application also claims the benefit under 35 U.S.C. § 119(a) of Chinese Patent Application No. 202211461129.3, filed on Nov. 16, 2022, and Chinese Patent Application No. 202223044861.9, filed on Nov. 16, 2022, which applications are incorporated herein by reference in their entireties.

### TECHNICAL FIELD

The present application relates to the technical field of tools and, in particular, to a cutting tool.

### BACKGROUND

An angle grinder is a cutting tool whose consumable accessory (for example, a cutting blade or a grinding disc) is driven to rotate by an electric motor to perform cutting or grinding work. The electric motor may selectively drive the working accessory to rotate forwards or reversely so that use requirements in different work scenarios are satisfied. Therefore, when using the angle grinder, the user needs to first select a rotation direction of the consumable accessory. From an existing angle grinder, the user cannot intuitively acquire working information about the cutting tool, for example, the rotation direction of the working accessory, which affects user experience.

### SUMMARY

A cutting tool includes: an electric motor capable of driving a working accessory to rotate; a cutting tool housing formed with a grip for a user to hold; a battery pack coupling portion connected to a battery pack for powering the cutting tool; and a control board electrically connected to the electric motor. The cutting tool further includes a display mechanism. The display mechanism includes: a control unit electrically connected to the control board; and a display assembly electrically connected to the control unit. The control unit transmits an electrical signal to the display assembly so that the display assembly displays a rotation direction of the electric motor.

In an example, the display mechanism further includes a first function button electrically connected to the control unit, and the first function button is capable of energizing the control unit to cause the display assembly to perform display.

In an example, the rotation direction of the electric motor is further capable of being switched through the first function button.

In an example, the first function button includes a first button and a second button, at least one of the first button and the second button is capable of energizing the control unit, and the first button and the second button are capable of correspondingly switching the rotation direction of the electric motor to forward rotation and reverse rotation, respectively.

In an example, the first function button and the display assembly are integrated with each other.

In an example, the display mechanism further includes a second function button electrically connected to the control unit, and the rotation direction of the electric motor is capable of being switched through the second function button.

In an example, the cutting tool further includes a first operation member capable of triggering the control board to be energized and causing the electric motor to rotate.

In an example, the cutting tool further includes a second operation member having a first position, a second position, and a third position. When the second operation member is at the first position, the whole cutting tool is de-energized. When the second operation member is at the second position, the first operation member is capable of energizing the control board and the control unit, the electric motor rotates forwards, and the display assembly performs corresponding display. When the second operation member is at the third position, the first operation member is capable of energizing the control board and the control unit, the electric motor rotates reversely, and the display assembly performs corresponding display.

In an example, the cutting tool further includes a first switch and a second switch, where the first operation member is capable of triggering the first switch, the first switch is electrically connected to the control board, the second operation member is capable of triggering the second switch, and the second switch is electrically connected to the control board.

In an example, the cutting tool housing is further formed with an electric motor housing connected to the grip, and the electric motor is disposed in the electric motor housing.

In an example, the display assembly is at least partially disposed at the intersection of the grip and the electric motor housing.

In an example, the cutting tool housing further includes a battery housing connected to the battery pack for powering the cutting tool, and the display mechanism is connected to the battery housing.

In an example, the display assembly includes one indicator capable of displaying different colors or words.

In an example, the display assembly includes two indicators, and each of the two indicators is capable of indicating one rotation direction of the electric motor.

In an example, the length of the cutting tool in a front and rear direction is less than or equal to 400 mm, and the width of the cutting tool in a left and right direction is less than or equal to 180 mm.

A cutting tool includes: an electric motor capable of driving a working accessory to rotate; a cutting tool housing formed with a grip for a user to hold; a battery pack coupling portion connected to a battery pack for powering the cutting tool; and a control board electrically connected to the electric motor. The grip is disposed between the electric motor and the battery pack. The cutting tool further includes a display mechanism. The display mechanism includes: a control unit electrically connected to the control board; and a display assembly electrically connected to the control unit. The control unit transmits an electrical signal to the display assembly so that the display assembly displays information about the cutting tool. The display mechanism is at least partially disposed at the intersection of the grip and an electric motor housing. The length of the cutting tool in a front and rear direction is less than or equal to 400 mm. The width of the cutting tool in a left and right direction is less than or equal to 180 mm.

In an example, the display mechanism further includes a first function button electrically connected to the control unit, the first function button is capable of energizing the control unit to cause the display assembly to perform display, and the first function button is capable of implementing at least one of regulating a speed of the electric motor, turning on and off the cutting tool, turning on and off an illumination assembly, adjusting the brightness of the illumination assembly, enabling and disabling a Bluetooth function, switching a working mode, switching a cutting mode, and unlocking and locking the electric motor.

A cutting tool includes: an electric motor capable of driving a working accessory to rotate; a cutting tool housing including an electric motor housing and a grip, where the electric motor is disposed in the electric motor housing, and the grip is held by a user; a battery pack coupling portion connected to a battery pack for powering the cutting tool; and a control board electrically connected to the electric motor, where after being energized, the control board is capable of controlling the electric motor to output a forward rotational movement or a reverse rotational movement; and a first function button electrically connected to the control board and capable of switching a rotation direction of the electric motor. When operating the first function button to switch the electric motor either from forward rotation to reverse rotation or from reverse rotation to forward rotation, the user applies a force to the first function button in the same direction.

In an example, the cutting tool further includes a display assembly electrically connected to the control board and capable of displaying information about the cutting tool.

In an example, the distance between the first function button and the display assembly is greater than or equal to 1 cm.

### BRIEF DESCRIPTION OF THE DRAWINGS

FIG. 1 is a structural view of a cutting tool from a first angle of view according to an example of the present application;

FIG. 2 is a structural view of a cutting tool from a second angle of view according to an example of the present application;

FIG. 3 is a structural view of a cutting tool with part of a cutting tool housing removed according to an example of the present application;

FIG. 4 is a partial structural view of a cutting tool according to an example of the present application;

FIG. 5 is a partial structural view of a cutting tool with a shaft-locking mechanism in a locking state according to an example of the present application;

FIG. 6 is a structural view of a shaft-locking mechanism locking a transmission shaft according to an example of the present application;

FIG. 7 is a partial structural view of a cutting tool with a shaft-locking mechanism in an unlocking state according to an example of the present application;

FIG. 8 is a structural view showing that a shaft-locking mechanism is separated from a transmission shaft according to an example of the present application;

FIG. 9 is a structural view showing that a shield mates with a baseplate according to an example of the present application;

FIG. 10 is a structural view showing that a shield mates with a first mounting member and a second mounting member according to an example of the present application;

FIG. 11 is a schematic view of the structure in FIG. 9 from another angle of view;

FIG. 12 is a structural view showing that a shield, a first mounting member, and a second mounting member are separated from each other according to an example of the present application;

FIG. 13 is a structural view showing that a shield, a first mounting member, and a second mounting member are separated from each other according to an example of the present application;

FIG. 14 is a schematic view showing that a display mechanism of a cutting tool is disposed at the intersection of a grip and an electric motor housing according to an example of the present application;

FIG. 15 is a first control schematic diagram of a cutting tool according to an example of the present application;

FIG. 16 is a first schematic view showing that a display mechanism of a cutting tool is disposed on an electric motor housing according to an example of the present application;

FIG. 17 is a second schematic view showing that a display mechanism of a cutting tool is disposed on an electric motor housing according to an example of the present application;

FIG. 18 is a structural diagram of a first panel according to an example of the present application;

FIG. 19 is a structural diagram of a second panel according to an example of the present application;

FIG. 20 is a structural diagram of a third panel according to an example of the present application;

FIG. 21 is a structural diagram of a fourth panel according to an example of the present application;

FIG. 22 is a second control schematic diagram of a cutting tool according to an example of the present application;

FIG. 23 is a third control schematic diagram of a cutting tool according to an example of the present application;

FIG. 24 is a structural view of a cutting tool with a first operation member and a second operation member according to an example of the present application;

FIG. 25 is a structural view of the structure in FIG. 24 from another angle of view;

FIG. 26 is a schematic view showing that a second operation member mates with a second switch according to an example of the present application;

FIG. 27 is another structural view of a cutting tool from a first angle of view according to an example of the present application; and

FIG. 28 is another structural view of a cutting tool from a second angle of view according to an example of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

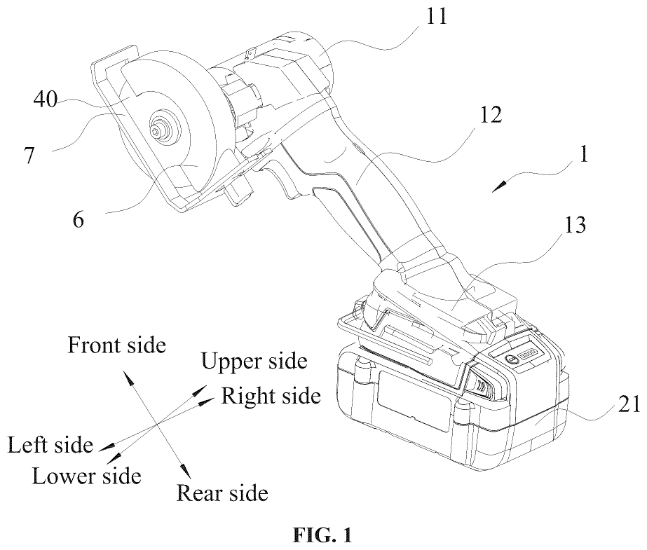

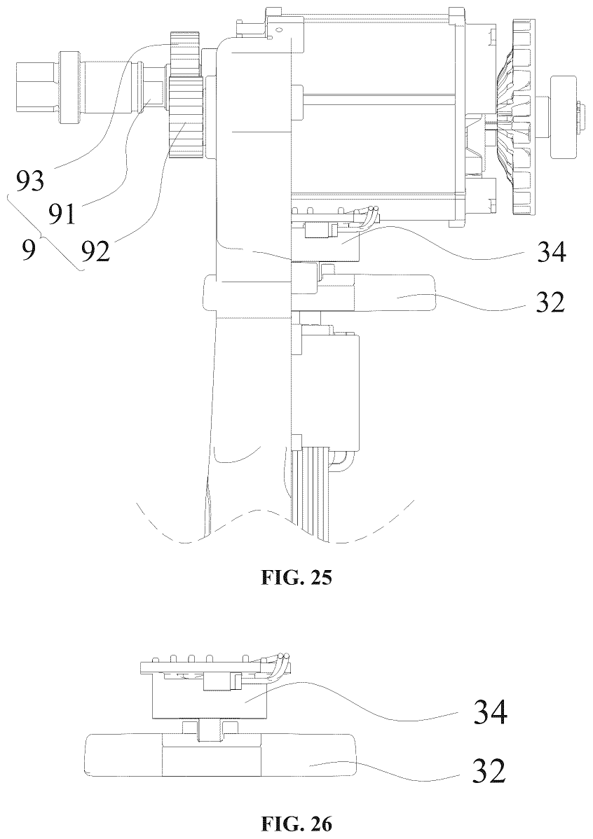

A cutting tool is provided in this example. Specifically, the cutting tool may be a handheld tool, a compact tool for cutting multiple materials, or a multi-function angle grinder for grinding and cutting. As shown in FIGS. 1 to 28, in this example, the cutting tool is an angle grinder, which is used as an example for description.

Orientations indicated by a front side, a rear side, an upper side, a lower side, a left side, and a right side in FIG. 1 each refer to orientations of the cutting tool relative to a user during use. As shown in FIGS. 1 to 3, the cutting tool includes a cutting tool housing 1, a battery pack coupling portion 23, a battery pack 21, an electric motor 22, and a control board 20. The electric motor 22 is supported on the cutting tool housing 1. The battery pack coupling portion 23 is mechanically connected to the cutting tool housing 1 or formed on the cutting tool housing 1. The battery pack coupling portion 23 is in circuit connected to the control board 20 electrically. The battery pack 21 is configured to power the whole cutting tool and is mounted by mating with the battery pack coupling portion 23. An output shaft 221 of the electric motor 22 is directly or indirectly connected to a working accessory 40. Specifically, the working accessory 40 may be a blade, a grinding disc, or the like. Both the battery pack 21 and the electric motor 22 are electrically connected to the control board 20. The control board 20 can control the electric motor 22 to start or stop. After being energized, the control board 20 can control the electric motor 22 to output a forward rotational movement or a reverse rotational movement, so as to drive the working accessory 40 to rotate forwards or reversely.

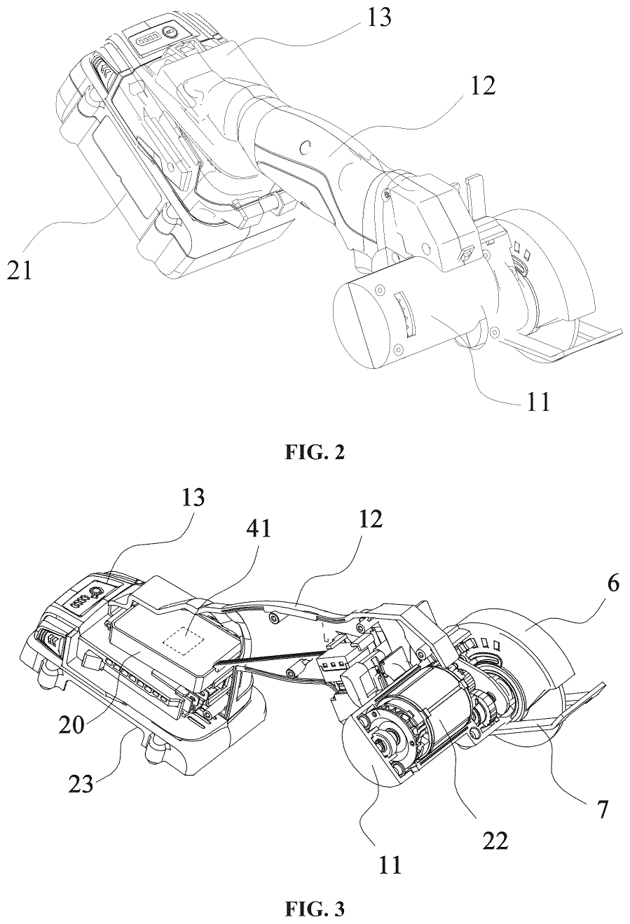

In this example, as shown in FIGS. 1 to 3, the cutting tool housing 1 sequentially includes an electric motor housing 11, a grip 12, and a battery housing 13 from front to rear. The electric motor 22 is mounted in the electric motor housing 11. The grip 12 is held by the user. The battery pack 21 is detachably connected to the battery housing 13. As an optional solution, as shown in FIG. 2, the grip 12 and the battery housing 13 make a whole. A left half housing and a right half housing are combined into the whole. A front half housing and a rear half housing are combined into the electric motor housing 11. In the cutting tool in this example, the parting surface of the whole formed by the grip 12 and the battery housing 13 is configured to be out of alignment with the parting surface of the electric motor housing 11, thereby facilitating the improvement of the structural strength of the whole cutting tool housing 1. As shown in FIG. 3, in this example, the battery pack coupling portion 23 includes an insertion slot formed on the battery housing 13 and further includes terminals (not shown in the figure) electrically connected to the control board 20. After the battery pack 21 is inserted into the insertion slot, each of the positive and negative electrodes of the battery pack 21 is connected to a respective one of the terminals.

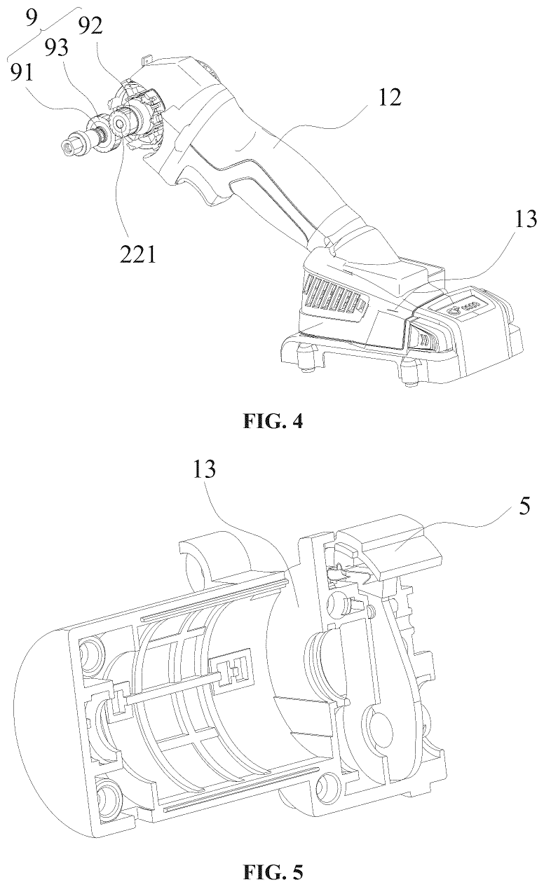

As shown in FIG. 4, the cutting tool further includes a transmission mechanism 9. An input end of the transmission mechanism 9 is connected to the output shaft 221 of the electric motor 22, and an output end of the transmission mechanism 9 (hereinafter referred to as a transmission shaft 91) is connected to the working accessory 40. The transmission shaft 91 is parallel to and spaced from the output shaft 221. The transmission mechanism 9 is provided so that the rotation axis (that is, the transmission shaft 91) of the working accessory 40 is disposed further outwards along the radial direction of the electric motor housing 11. Thus, a cutting depth of the working accessory 40 can be increased. In this example, the transmission mechanism 9 is provided so that the cutting depth of the working accessory 40 can reach 19 mm.

In an example, as shown in FIG. 4, the transmission mechanism 9 includes a first gear 92, a second gear 93, and the transmission shaft 91. The transmission shaft 91 is rotatably supported on the cutting tool housing 1. The first gear 92 is connected to the output shaft 221 of the electric motor 22. The second gear 93 is connected to the transmission shaft 91. The first gear 92 meshes with the second gear 93. When the electric motor 22 rotates, the first gear 92 and the second gear 93 rotate so that the transmission shaft 91 can drive the working accessory 40 to rotate. It is to be understood that in another example, a specific structure of the transmission mechanism 9 is not limited thereto and is adjustable according to actual requirements.

In an example, as shown in FIGS. 5 to 8, the cutting tool further includes a shaft-locking mechanism 5. The shaft-locking mechanism 5 can selectively lock the output shaft 221 of the electric motor 22 or the transmission shaft 91 so that the working accessory 40 cannot rotate. When the shaft-locking mechanism 5 is in a locking state where the output shaft 221 or the transmission shaft 91 is locked, the working accessory 40 can be prevented from rotating accidentally due to a mis-operation by the user. Further, the injury to the user caused by the mis-operation is avoided. When the cutting tool is required to work normally, the shaft-locking mechanism 5 is switched to an unlocking state.

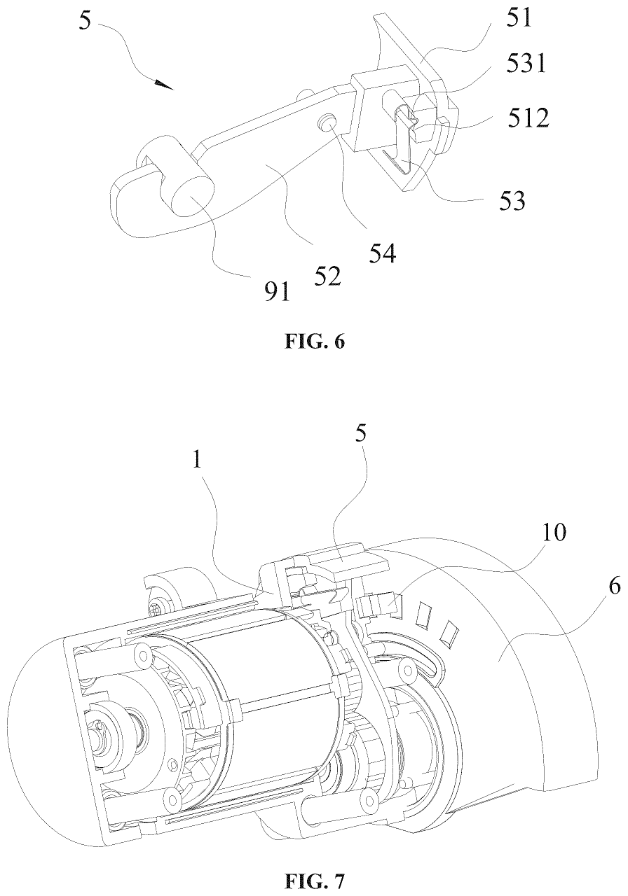

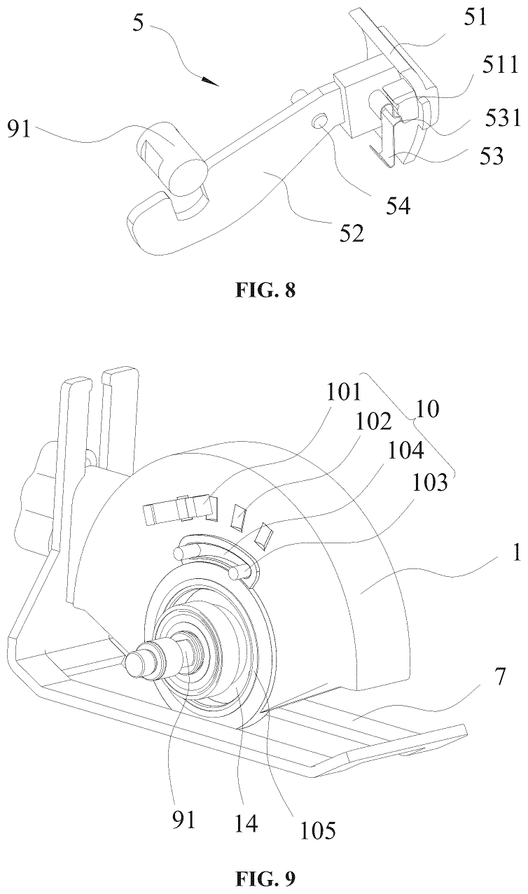

In this example, as shown in FIGS. 5 to 8, the shaft-locking mechanism 5 includes a toggle member 51, a locking hook 52, and a pivot shaft 54. The locking hook 52 is pivotally connected to the cutting tool housing 1 through the pivot shaft 54. A slot is provided at one end of the locking hook 52, and the toggle member 51 is connected to the other end of the locking hook 52. When the user drives the toggle member 51 to rotate around the pivot shaft 54, the transmission shaft 91 can be hooked in the slot of the locking hook 52 so that the transmission shaft 91 is not rotatable, or the locking hook 52 is separated from the transmission shaft 91 so that the transmission shaft 91 is unlocked. In this example, the shaft-locking mechanism 5 further includes a first spring contact 53. The first spring contact 53 is connected to the cutting tool housing 1. A first protrusion 531 is provided on the first spring contact 53. A groove 511 and a step 512 next to the groove 511 are provided on the toggle member 51. In the process where the toggle member 51 is driven to rotate, the first protrusion 531 of the first spring contact 53 can selectively engage, in a snap-fit manner, with the groove 511 or the side of the step 512 facing away from the groove 511 so that the shaft-locking mechanism 5 remains in the locking or unlocking state. Specifically, the first spring contact 53 has a certain deformation capability along the depth direction of the groove 511 so that the first protrusion 531 can protrude from the groove 511 under a certain acting force. As shown in FIG. 6, when the user drives the toggle member 51 to rotate and the first protrusion 531 engages with the groove 511, the slot on the locking hook 52 just engages with the transmission shaft 91 so that the shaft-locking mechanism 5 is caused to remain in the locking state. As shown in FIG. 8, when the user drives the toggle member 51 to rotate reversely and the first protrusion 531 engages with the side of the step 512 facing away from the groove 511, the locking hook 52 is separated from the transmission shaft 91 so that the shaft-locking mechanism 5 is caused to remain in the unlocking state. It is to be understood that a specific shape of the first spring contact 53 may be configured by those skilled in the art according to requirements and is not specifically limited herein.

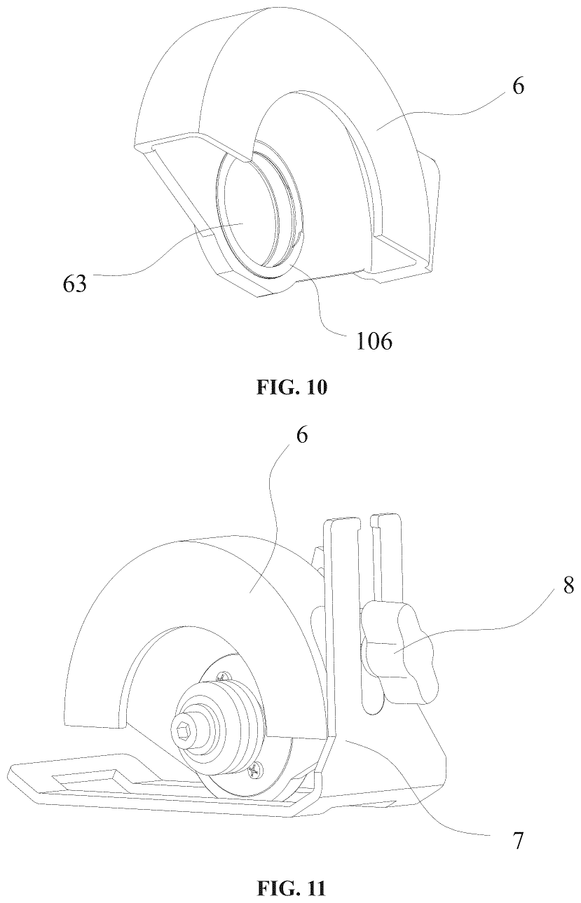

As shown in FIGS. 1 and 9, a cutting mechanism further includes a shield 6. The shield 6 is connected to the cutting tool housing 1 and can cover part of the working accessory 40 to prevent flying chips generated in a cutting process of the working accessory 40 from being spattered on the user. According to actual working requirements, the working accessory 40 has different positions relative to a workpiece. Therefore, the angle of the shield 6 relative to the working accessory 40 (that is, the angle of the shield 6 relative to the cutting tool housing 1 needs to be adjusted so that it is ensured that the shield 6 protects the user reliably. In this example, the shield 6 rotatably mates with the cutting tool housing 1. Specifically, as shown in FIGS. 9 and 10, a mounting portion 14 is formed on the cutting tool housing 1. The mounting portion 14 is connected to or integrally formed with the electric motor housing 11. The shield 6 is provided with a central hole 63. The central hole 63 of the shield 6 is sleeved on the mounting portion 14 and is rotatable relative to the mounting portion 14. The rotation axis of the shield 6 is collinear with the rotation axis of the working accessory 40.

As shown in FIG. 9, the cutting mechanism further includes a quick adjustment mechanism 10. In the process where the user rotates the shield 6, the quick adjustment mechanism 10 can cause the shield 6 to be quickly locked at a preset angle. The quick adjustment mechanism 10 includes a second spring contact 101 and multiple locking slots 102. The second spring contact 101 is connected to the cutting tool housing 1 and formed with a second protrusion. The multiple locking slots 102 are provided on the shield 6. When the user rotates the shield 6, the second spring contact 101 is pressed, and the second protrusion abuts against a position of the shield 6 with no locking slot, thereby generating a certain resistance to the rotation of the shield 6. When the second protrusion on the second spring contact 101 faces any locking slot 102, the second protrusion can snap into the locking slot 102 so as to lock the shield 6 at an angle, thereby quickly adjusting the angle of the shield 6. Specifically, the multiple locking slots 102 are provided on the side of the shield 6 facing the cutting tool housing 1 and are distributed along the same arc. The center of the arc is on the straight line where the transmission shaft 91 is located. The second spring contact 101 and each of the multiple locking slots 102 cooperate with each other so that the quick adjustment and locking of the angle of the shield 6 can be implemented.

As shown in FIG. 9, the quick adjustment mechanism 10 further includes a limit member 103 and a limit groove 104. The limit groove 104 is provided on the shield 6. One end of the limit member 103 is connected to the cutting tool housing 1, and the other end of the limit member 103 is slidable in the limit groove 104. The limit member 103 and the limit groove 104 cooperate with each other so that the rotation range of the shield 6 can be limited. In this example, the limit groove 104 is provided on the side of the shield 6 facing the cutting tool housing 1. The limit groove 104 is configured to be an arc-shaped groove, and the center of the arc-shaped groove is on the straight line where the transmission shaft 91 is located. The central angle corresponding to the arc-shaped groove is the maximum rotation angle of the shield 6, which may be adjusted by those skilled in the art according to the actual requirements and is not limited herein.

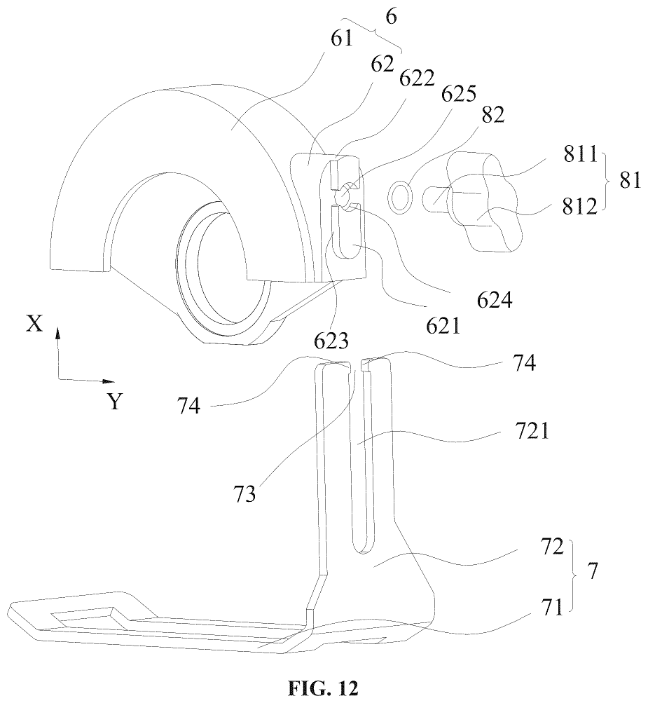

As shown in FIG. 11, the cutting tool further includes a baseplate 7. The baseplate 7 is connected to the shield 6 and used for abutting against the workpiece in the cutting process to limit the cutting depth of the working accessory 40. As shown in FIG. 12, the baseplate 7 includes an abutment portion 71 and a connection portion 72. The abutment portion 71 is used for abutting against the workpiece, and the connection portion 72 is used for connecting to the shield 6. In this example, the position of the baseplate 7 relative to the shield 6 is adjustable so that the cutting depth of the working accessory 40 is adjustable according to the requirements.

In the related art, the baseplate is connected to the shield through a fastener. When the cutting tool is used, the position of the baseplate relative to the shield needs to be adjusted or the baseplate needs to be directly removed according to different actual working scenarios. If the user does not hold the baseplate reliably after releasing an adjustment assembly, the baseplate will fall off, causing damage to the user or the workpiece.

In this regard, in this example, as shown in FIG. 12, the shield 6 includes a shield body 61 and a mating portion 62. The shield body 61 is used for covering the working accessory 40. The central hole 63 is provided on the shield body 61. The mating portion 62 is connected to the shield body 61 and disposed on the side of the shield 6 facing the connection portion 72. The connection portion 72 is provided with a guide hole 721 whose length extends along a first direction (an X direction in FIG. 12). The cutting tool further includes an adjustment assembly 8. The adjustment assembly 8 includes a fastener 81. The fastener 81 penetrates through the guide hole 721 and is movably connected to the shield 6. An opening 73 which can be passed through by the adjustment assembly 8 along the first direction is provided at one end of the guide hole 721. Limit portions 74 protrude and are disposed at the opening 73 and can lap the mating portion 62 along the first direction.

When the position of the baseplate 7 is adjusted, the fastener 81 is unscrewed and the baseplate 7 is moved relative to the shield 6 along the length direction of the guide hole. Since the limit portions 74 disposed at the opening 73 of the guide hole 721 can lap and mate with the mating portion 62 of the shield 6, the movement of the baseplate 7 along the first direction can be stopped and limited. Thus, the baseplate 7 can be prevented from falling off accidentally, and the risk is reduced that the workpiece is damaged or the user is injured. In addition, the opening 73 is provided at the end of the guide hole 721 and can be passed through by the adjustment assembly 8 along the first direction. Therefore, after the fastener 81 is unscrewed, the user operates the baseplate 7 to move along a preset track so that the baseplate 7 can be detached from the shield 6 and the fastener 81 separately. That is, on the basis that the adjustment assembly 8 does not need to be completely detached, the baseplate 7 can be detached. Thus, the operation is more convenient.

As shown in FIG. 12, the fastener 81 includes a penetrating member 811 and a grip member 812. The penetrating member 811 penetrates through the guide hole 721 and is movably connected to the shield 6. The penetrating member 811 can pass through the opening 73 along the first direction so that the baseplate 7 can be conveniently detached from the shield 6. The grip member 812 is connected to the end of the penetrating member 811 facing away from the shield 6. The cross-sectional area of the grip member 812 is larger than the cross-sectional area of the penetrating member 811 so that the grip member 812 is not only convenient for the user to hold and rotate but also capable of stopping the connection portion 72 of the baseplate 7 along the penetrating direction of the penetrating member 811. Thus, the baseplate 7 is prevented from falling off along the penetrating direction of the penetrating member 811. In this example, a threaded hole 625 is provided on the mating portion 62, the penetrating member 811 is a threaded rod, and the threaded rod threadedly mates with the threaded hole 625. The grip member 812 abuts against the connection portion 72 of the baseplate 7 along the axial direction of the threaded rod so that the position of the baseplate 7 and the position of the shield 6 can be locked relative to each other. In this example, the penetrating member 811 extends along a second direction. The second direction is a Y direction in FIG. 12, and the Y direction is perpendicular to the X direction.

In an example, as shown in FIG. 12, the mating portion 62 includes a guide boss 621 extending along the first direction. The guide hole 721 is slidable along the guide boss 621. The limit portions 74 can lap an end surface 622 of the guide boss 621 along the first direction. The guide boss 621 can not only guide a movement direction of the baseplate 7 but also mate with the limit portions 74 so that the baseplate 7 can be prevented from falling off accidentally in the process of sliding along the first direction. In addition, since the limit portions 74 can abut against the end face 622 of the guide boss 621, a movement track of the baseplate 7 during the detachment is limited. Thus, the baseplate 7 can be better prevented from falling off. In this example, the threaded hole 625 penetrates through the guide boss 621. When the position of the baseplate 7 relative to the shield 6 needs to be adjusted, the fastener 81 only needs to be slightly rotated so that the fastener 81 moves a relatively short distance along the axial direction of the fastener 81 and the connection portion 72 of the baseplate 7 is enabled to slide relative to the guide boss 621. In this case, due to the existence of the limit portions 74, the baseplate 7 can be well prevented from accidentally falling off. When the baseplate 7 needs to be detached, the fastener 81 is rotated and the distance that the fastener 81 moves along the Y direction is greater than the thickness of the connection portion 72. Thus, the distance between the grip member 812 and the limit boss along the Y direction is greater than the thickness of the connection portion 72. In this case, the user grips the baseplate 7 and moves the connection portion 72 away from the shield 6 along the Y direction. When the guide hole 721 on the baseplate 7 and the guide boss 621 are completely detached from each other, the opening 73 of the guide hole 721 of the connection portion 72 directly faces the penetrating member 811. Then, the baseplate 7 is moved along the X direction and the penetrating member 811 is moved out from the opening 73. Thus, the detachment of the baseplate 7 can be implemented.

In this example, as shown in FIG. 12, the number of the limit portions 74 is two. The two limit portions 74 are provided, one to one, on two sidewalls of the guide hole 721 that face each other. The gap between the two limit portions 74 forms the opening 73. The two limit portions 74 are provided so that the connection portion 72 of the baseplate 7 can abut against the end surface 622 of the guide boss 621 more stably. Thus, the baseplate 7 can be more stably and reliably prevented from accidentally falling off.

In an example, as shown in FIG. 12, the adjustment assembly 8 further includes a damping member 82. The damping member 82 can hinder the connection portion 72 from sliding relative to the mating portion 62 along the first direction. Therefore, when the baseplate 7 is adjusted to move relative to the shield 6 along the X direction, the movement of the baseplate 7 is damped to a certain degree so that the baseplate 7 can be suspended at any position of the guide boss 621 and is more convenient to adjust. Optionally, the damping member 82 is connected to one of the guide boss 621 and the connection portion 72 and abuts against the other one of the guide boss 621 and the connection portion 72 so that the shield 6 can be damped in the process where the baseplate 7 moves relative to the shield 6.

As shown in FIG. 12, sidewalls of the guide boss 621 which are configured to face the guide hole 721 separately are first sidewalls 623. An accommodation slot 624 is provided on the guide boss 621. The accommodation slot 624 penetrates through at least one of the first sidewalls 623. The damping member 82 is disposed in the accommodation slot 624 and at least partially protrudes from the first sidewalls 623 to abut against the sidewalls of the guide hole 721. The accommodation slot 624 limits the damping member 82, can prevent the damping member 82 from falling off, and ensures that the damping member 82 can abut against the sidewalls of the guide hole 721. In this example, the accommodation slot 624 penetrates through the two first sidewalls 623 so that two ends of the damping member 82 can protrude from the two first sidewalls 623 one to one and abut against the two sidewalls of the guide hole 721 one to one. Thus, the movement of the baseplate 7 relative to the shield 6 is damped more reliably.

Optionally, the damping member 82 is annular. The fastener 81 penetrates through the damping member 82 and is connected to the shield 6. The fastener 81 penetrates through the damping member 82 so that the damping member 82 can be prevented from accidentally falling off and being lost. In this example, the damping member 82 is a rubber ring. In another example, the damping member 82 may be made of another material that has a certain elastic deformation capability, which is not specifically limited herein.

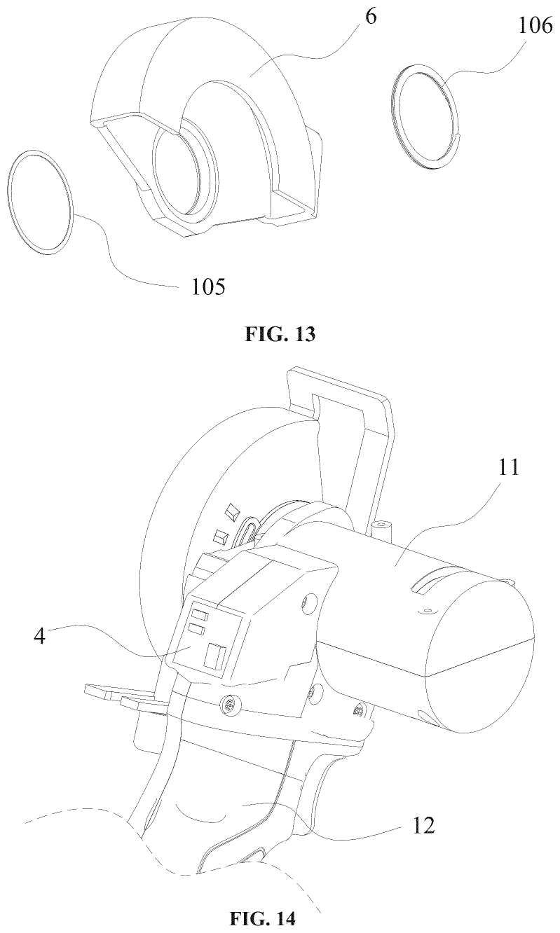

In this example, as shown in FIGS. 9 and 13, the quick adjustment mechanism 10 further includes a first mounting member 105 and a second mounting member 106. The first mounting member 105 and the second mounting member 106 are each sleeved on the mounting portion 14 and abut against two sides of the shield 6, respectively. The first mounting member 105 and the second mounting member 106 are provided so that the shield 6 can be limited in an axial direction, thereby preventing the shield 6 from playing along the axial direction. In this example, the first mounting member 105 is a Belleville spring, and the second mounting member 106 is a circlip. The Belleville spring may generate an axial pressing force on the shield 6. Therefore, the shield 6 also generates an axial pressing force on the Belleville spring and the circlip. When the user rotates the shield 6, the pressing force increases the friction force between the shield 6 and the first mounting member 105 and the friction force between the shield 6 and the second mounting member 106 separately, thereby damping the rotation of the shield 6.

In the cutting process of the cutting tool, the user applies certain downward pressure to the cutting tool. Further, the cutting tool generates downward pressure on the workpiece. Therefore, the workpiece generates a corresponding reacting force on the baseplate 7. The reacting force may cause the baseplate 7 and the shield 6 to rotate.

In this example, each of the second spring contact 101 and the Belleville spring generates a resistance to the rotation of the shield 6. The preceding two resistances are superimposed so that the shield 6 needs to overcome a sufficient acting force during the rotation. Thus, the shield 6 is prevented from rotating due to the reacting force of the workpiece against the baseplate 7. In this example, a resistance of at least 30 N needs to be overcome at the maximum outer diameter of the shield 6 so that the shield 6 can be rotated. With the resistance of 30 N, the baseplate 7 and the shield 6 can be caused to not rotate due to the downward pressure normally applied by the user when the baseplate 7 is in contact with the workpiece in a working process of the cutting tool. When the user needs to adjust the angle of the shield 6, the resistance of 30 N is relatively easy for the user to overcome.

When using the cutting tool, the user needs to first select a rotation direction of a consumable accessory. From an existing cutting tool, the user cannot intuitively acquire information about the cutting tool, for example, a rotation direction of the working accessory 40, which affects user experience.

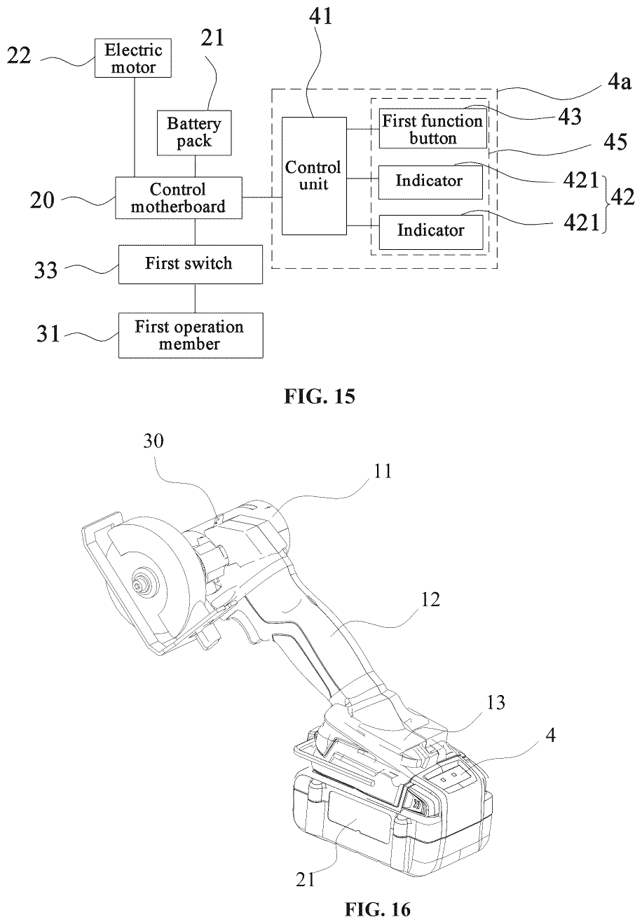

By contrast, in this example, as shown in FIGS. 14 and 15, the cutting tool further includes a display mechanism 4. The display mechanism 4 includes a control unit 41 and a display assembly 42. The control unit 41 is electrically connected to the control board 20. The display assembly 42 is electrically connected to the control unit 41. The control unit 41 transmits an electrical signal to the display assembly 42 so that the display assembly displays information about the cutting tool. Optionally, the information about the cutting tool includes a rotation direction of the electric motor. Therefore, the user can intuitively observe a direction in which the electric motor 22 currently drives or is about to drive a consumable accessory to rotate. Thus, it can be more convenient to adjust the rotation direction of the electric motor 22 to a required direction, thereby improving the user experience. It is to be noted that “the rotation direction of the electric motor 22” described herein includes not only a current rotation direction of the electric motor 22 in a rotating state but also a direction in which the electric motor 22 is about to rotate after the control board 20 is triggered to be energized, where the electric motor 22 does not rotate currently.

In some examples, the information about the cutting tool further includes: a current rotational speed of the electric motor, the on/off state of the cutting tool, the on/off state of an illumination assembly, a brightness level of the illumination assembly, information about remaining electrical energy of the battery pack, a Bluetooth connection state, the locked and unlocked states of the electric motor, working modes and states (the working modes include a light-load mode and a heavy-load mode), and cutting modes and states (the cutting modes include a normal cutting mode and a special cutting mode). In the normal cutting mode, after a first operation member 31 is released, the electric motor automatically stops rotating. In the special cutting mode, when it is detected that a no-load state is entered after the completion of cutting, the electric motor automatically reduces its speed or shuts down.

In this example, as shown in FIGS. 14 and 15, the display mechanism 4 further includes a panel 45. The display assembly 42 is disposed on the panel 45. The panel 45 is connected to the cutting tool housing 1 or embedded in the cutting tool housing 1. The panel 45 is disposed so that it is convenient to mount the display assembly 42. As shown in FIG. 3, the control unit 41 is connected to the panel 45 and disposed in the cutting tool housing 1.

In an example, as shown in FIG. 14, the display mechanism 4 is at least partially disposed at the intersection of the grip 12 and the electric motor housing 11. In this example, the display assembly 42 of the display mechanism 4 is mounted on the cutting tool housing 1 so that it is convenient for the user to observe the display assembly 42 of the display mechanism 4. Moreover, the control unit 41 is disposed in the cutting tool housing 1 so that the cutting tool housing 1 plays a role of protecting the control unit 41 reliably.

Optionally, the display assembly 42 is disposed at the intersection of the grip 12 and the electric motor housing 11. Thus, after the user uses the cutting tool and holds the grip 12, it can be convenient for the user to observe content displayed by the display assembly 42. Specifically, the display assembly 42 is connected to the upper side of the intersection of the grip 12 and the electric motor housing 11. In this example, the control unit 41 may be disposed in the intersection of the grip 12 and the electric motor housing 11 so that it is convenient for the control unit 41 to be electrically connected to the display assembly 42. Of course, the control unit 41 may be disposed at another position in the cutting tool housing 1 according to actual space arrangement requirements, for example, a position adjacent to the battery housing 13 on the lower side of the grip 12.

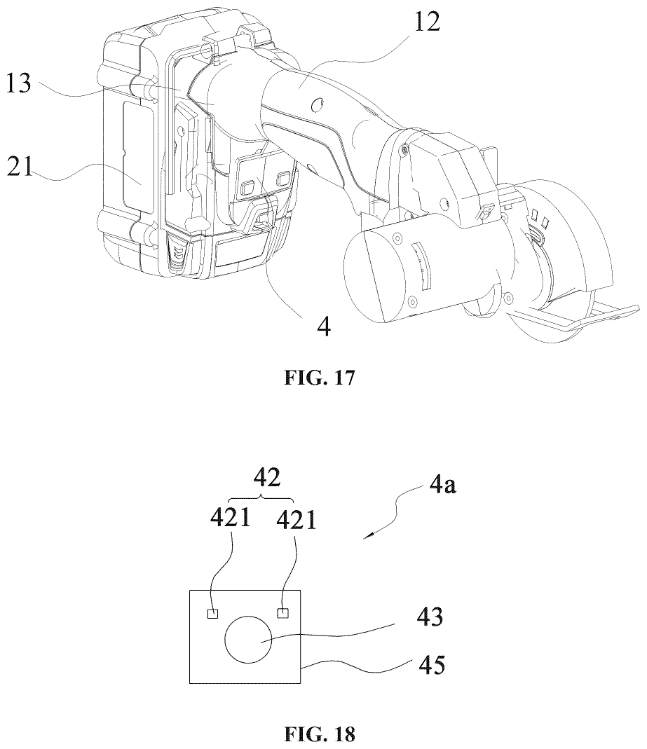

Optionally, the display assembly 42 of the display mechanism 4 is connected to the battery housing 13. In some examples, as shown in FIG. 16, the display assembly 42 of the display mechanism 4 may be disposed on the upper sidewall of the battery housing 13. In another example, as shown in FIG. 17, the display assembly 42 of the display mechanism 4 may be disposed on the front sidewall of the battery housing 13. It is to be understood that those skilled in the art may adjust the position of the display assembly 42 on the cutting tool housing 1 according to the actual requirements. The position of the display assembly 42 is not specifically limited herein. Optionally, the cutting mechanism further includes an illumination assembly 30. The illumination assembly 30 is mounted at the intersection of the electric motor housing 11 and the grip 12. The illumination assembly 30 is configured to illuminate the side of the workpiece during the use of the cutting tool.

It is to be noted that according to the technical solutions disclosed in FIG. 3, FIG. 16 and FIG. 17, the control unit 41 and the control board 20 may be combined into one integrated control board to save a space and a material. When the control unit 41 and the control board 20 are combined into the integrated control board, each of the control unit 41 and the control board 20 herein is part of the integrated control board. Although the control unit 41 and the control board 20 are given two different names herein, this does not mean that the two cannot be combined into a single control board. Of course, the control unit 41 and the control board 20 may be two independent control boards to be mounted together and remain electrically connected to each other.

Optionally, as shown in FIG. 18, the display assembly 42 includes two indicators 421. Each indicator 421 is configured to indicate one rotation direction of the electric motor 22. For example, one of the two indicators 421 is on, indicating that the electric motor 22 rotates forwards, and the other one of the two indicators 421 is on, indicating that the electric motor 22 rotates reversely. In this solution, each of the two indicators 421 may be a light-emitting diode (LED) lamp. Optionally, the shield 6 of the cutting tool is marked with a forward rotation arrow and a reverse rotation arrow and corresponding letters such as “F” and “R”. Correspondingly, each of the two indicators 421 is marked with a respective one of the letters.

In another example (not shown in the figure), the display assembly 42 includes one indicator 421 that can display different colors to indicate rotation directions outputted by the electric motor 22. For example, green indicates forward rotation and red indicates reverse rotation. In this solution, the indicator 421 may be an LED lamp. In another solution, the indicator 421 may directly display different words for indication. For example, the word “forward” is used for indicating the forward rotation of the electric motor 22, and the word “reverse” is used for indicating the reverse rotation of the electric motor 22. In this solution, the indicator 421 may be an LED display screen.

Optionally, as shown in FIGS. 15 and 18, the display mechanism 4a further includes a first function button 43. The first function button 43 is electrically connected to the control unit 41 and can cause the control unit 41 to be energized so that the display assembly 42 performs display. When the user triggers the first function button 43, the control unit 41 is energized, and the display assembly 42 displays the rotation direction of the electric motor 22. Thus, the user can intuitively observe the rotation direction of the electric motor 22. That is, in this example, when the control board 20 is not energized and the electric motor 22 does not start rotating, the user can observe the rotation direction of the electric motor 22, thereby further improving the user experience. In this example, the first function button 43 is also disposed on the panel 45 so that the first function button 43 is convenient for the user to operate. In another example, the first function button 43 may include multiple buttons. The multiple buttons implement the functions of regulating a speed of the electric motor, turning on and off the whole cutting tool, turning on and off the illumination assembly, adjusting the brightness of the illumination assembly, enabling and disabling a Bluetooth function, switching a working mode, switching a cutting mode, and unlocking and locking the electric motor, respectively. In an example, the first function button 43 may implement at least one of the functions described above.

In this example, the cutting tool further includes the first operation member 31 and a first switch 33. The first switch 33 is electrically connected to the control board 20. The first operation member 31 is operated by the user and can trigger the first switch 33 to perform an action. After the first operation member 31 triggers the first switch 33, the control board 20 is energized so that the electric motor 22 can be driven to rotate. Specifically, the first operation member 31 may be a trigger.

Optionally, the first function button 43 can further switch the rotation direction of the electric motor 22. That is, with the display mechanism 4, the user can not only observe the rotation direction of the electric motor 22, but also switch the rotation direction of the electric motor 22, thereby further improving the user experience.

In an example, as shown in FIG. 18, the first function button 43 includes one button. The first function button 43 is used in the manner described below. When the first function button 43 is pressed for the first time, the control unit 41 is energized. When the first function button 43 is pressed for the second time, the display assembly 42 displays the forward rotation of the electric motor 22 (or the reverse rotation of the electric motor 22), an electric motor driver circuit on the control board 20 corresponds to the forward rotation (or the reverse rotation). When the first function button 43 is pressed for the third time, the electric motor driver circuit on the control board 20 is switched to stopping the rotation. When the first function button 43 is pressed for the fourth time, the rotation direction of the electric motor 22 displayed by the display assembly 42 is switched, and the electric motor driver circuit on the control board 20 corresponds to switching at the same time. It is to be noted that the electric motor driver circuit on the control board 20 includes a flash memory. The flash memory can store data in the case where the control board 20 is not energized. In another example, the first function button 43 may be used in the manner described below. When the first function button 43 is pressed for the first time, the control unit 41 is energized, and the display assembly 42 displays a default rotation direction of the electric motor 22 at the same time. When the first function button 43 is pressed for the second time, the rotation direction of the electric motor 22 displayed by the display assembly 42 is switched, and the electric motor driver circuit on the control board 20 corresponds to switching at the same time. When the first function button 43 is pressed for the third time, the control unit 41 is de-energized.

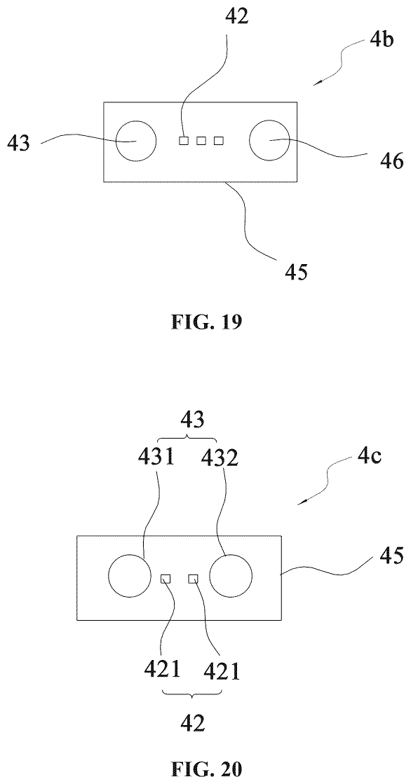

Optionally, as shown in FIG. 19, different from the display mechanism 4a, the display mechanism 4b further includes a locking button 46 electrically connected to the control unit 41 and configured to electronically lock the electric motor 22. That is, after the locking button 46 is pressed, even if the control board 20 is energized, the electric motor 22 still cannot output any rotational movement.

In another example, as shown in the display mechanism 4c in FIG. 20, the first function button 43 includes a first button 431 and a second button 432. Each of the first button 431 and the second button 432 can energize the control unit 41. The first button 431 and the second button 432 can correspondingly switch the rotation direction of the electric motor 22 to the forward rotation and the reverse rotation, respectively. The first button 431 and the second button 432 are used in the specific manner described below. When the first button 431 is pressed first, the control unit 41 is energized, the display assembly 42 displays the forward rotation of the electric motor 22, and the electric motor driver circuit on the control board 20 corresponds to the forward rotation at the same time. When the second button 432 is pressed next, the display assembly 42 displays the reverse rotation of the electric motor 22, and the electric motor driver circuit on the control board 20 is switched to the reverse rotation at the same time. When the second button 432 is pressed first, the control unit 41 is energized, the display assembly 42 displays the reverse rotation of the electric motor 22, and the electric motor driver circuit on the control board 20 corresponds to the reverse rotation at the same time. When the first button 431 is pressed next, the display assembly 42 displays the forward rotation of the electric motor 22, and the electric motor driver circuit on the control board 20 is switched to the forward rotation at the same time.

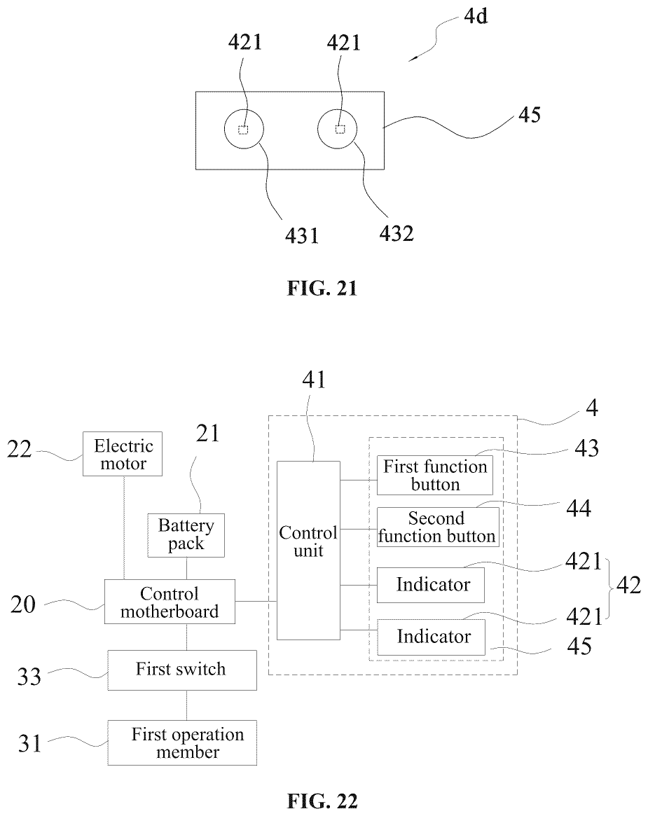

In another example, as shown in the display mechanism 4d in FIG. 21, the first function button 43 includes the first button 431 and the second button 432, and the first function button 43 and the display assembly 42 are integrated with each other. Specifically, one indicator 421 of the display assembly 42 is mounted below the first button 431, and the other indicator 421 of the display assembly 42 is mounted below the second button 432 so that fewer components are disposed on the panel 45. In this example, the first button 431 and the second button 432 are used in the same specific manner as the first button 431 and the second button 432 in the preceding example. The details are not repeated here.

In an example, as shown in FIG. 22, the display mechanism 4 includes a first function button 43 and a second function button 44. The first function button 43 is configured to energize the control unit 41, and the second function button 44 can switch a rotation direction outputted by the electric motor 22.

A cutting tool is further provided in an example. The cutting tool includes an electric motor 22, a cutting tool housing 1, a battery pack coupling portion 23, and a control board 20. The electric motor 22 can drive a working accessory to rotate. The cutting tool housing 1 is formed with a grip 12 for the user to hold. The battery pack coupling portion 23 is connected to a battery pack for powering the cutting tool. The control board 20 is electrically connected to the electric motor 22. After being energized, the control board 20 can control the electric motor 22 to output a forward rotational movement or a reverse rotational movement. The cutting tool further includes a first function button 43 electrically connected to the control board 20 and capable of switching a rotation direction of the electric motor 22. When operating the first function button 43 to switch the electric motor 22 either from the forward rotation to the reverse rotation or from the reverse rotation to the forward rotation, the user applies a force to the first function button 43 in the same direction.

That is to say, in this example, the first function button 43 may be a push switch but cannot be a displaceable component, for example, a toggle or a push button that needs to be toggled in different directions such as a left and right direction or a front and rear direction. The user performs the first operation on the first function button 43 such that the electric motor 22 can be triggered to change the rotation direction once. The user performs the second operation on the first function button 43 such that the electric motor 22 can be triggered to change the rotation direction again. The “operation” here may refer to a push. In an implementation of this example, the cutting tool may further include a display assembly 42 electrically connected to the control board 20 and capable of displaying information about the cutting tool. The distance between the first function button 43 and the display assembly is greater than or equal to 10 mm, 15 mm, 20 mm, 25 mm, 30 mm, 40 mm, 50 mm, 60 mm, 70 mm, 80 mm, or 90 mm. That is to say, the first function button 43 and the display assembly 42 are separately disposed independently of each other. For example, the first function button 43 is disposed near the battery pack coupling portion 23, and the display assembly 42 is disposed at the intersection of the grip 12 and the cutting tool housing 1. Thus, the first function button 43 and the display assembly 42 are not only convenient for the user to operate but also convenient for the user to observe.

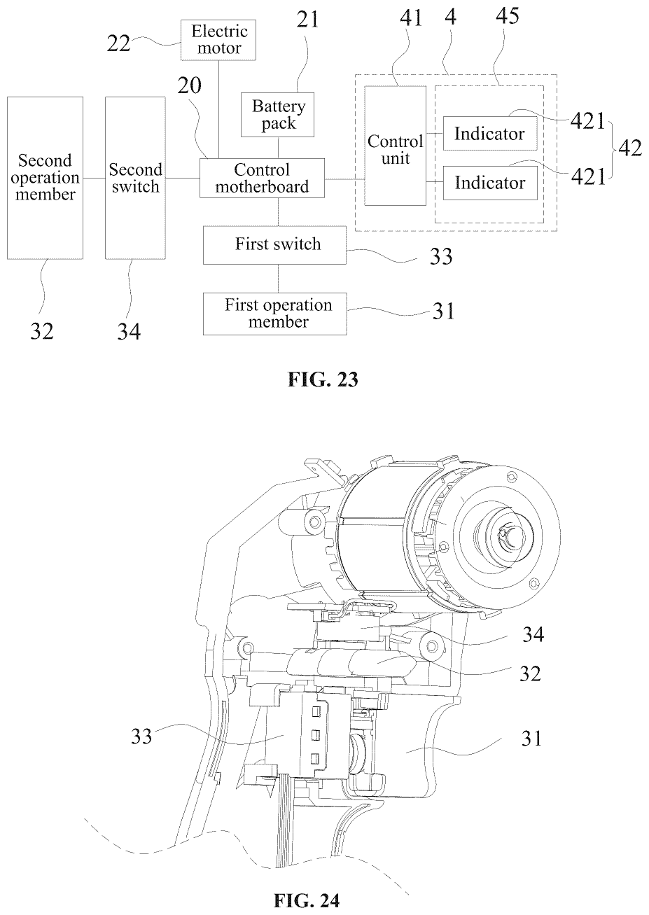

In an example, as shown in FIGS. 23 to 26, the cutting tool includes a first operation member 31 and a second operation member 32. The first operation member 31 can trigger the control board 20 to be energized and cause the electric motor 22 to rotate. The second operation member 32 has a first position, a second position, and a third position. When the second operation member 32 is at the first position, the whole cutting tool is de-energized. In this case, the electric motor 22 does not rotate if the first operation member 31 is operated. When the second operation member 32 is at the second position, the first operation member 31 is operated in this case such that the control board 20 and a control unit 41 can be energized, the electric motor 22 rotates forwards, and the display assembly 42 performs corresponding display. When the second operation member 32 is at the third position, the first operation member 31 is operated in this case such that the control board 20 and the control unit 41 can be energized, the electric motor 22 rotates reversely, and the display assembly 42 performs corresponding display. That is, in this example, before using the cutting tool, the user first selects the rotation direction of the electric motor 22 by operating the second operation member 32. Then, the user operates the first operation member 31 to energize the control board 20 and cause the electric motor 22 to start rotating, and the display assembly 42 displays a current rotation direction of the electric motor at the same time. If this rotation direction is not a required rotation direction, the user operates the second operation member 32 again to switch the rotation direction of the electric motor 22. In this case, the first operation member 31 is operated again so that the electric motor 22 can rotate in the required direction. In this example, the first operation member 31 may be a trigger, and the second operation member 32 is a toggle switch.

Specifically, as shown in FIGS. 23 and 24, the cutting tool further includes a first switch 33 and a second switch 34. The first switch 33 is electrically connected to the control board 20. The first operation member 31 is configured to trigger the first switch 33. The second switch 34 is electrically connected to the control board 20. The second operation member 32 is configured to trigger the second switch 34. Optionally, the shield 6 of the cutting tool is marked with a forward rotation arrow and a reverse rotation arrow and corresponding letters such as “F” and “R”. Correspondingly, each of the second position and the third position of the second operation member 32 is marked with a respective one of the letters. In an example, the first switch 33 and the second switch 34 may output electrical signals to the control unit.

In an example, the cutting tool is a handheld cutting tool that can implement grinding or cutting. That is to say, a working accessory that can be mounted to the cutting tool may be a grinding disc or a saw blade. The length of the cutting tool in the front and rear direction is less than or equal to 400 mm, and the width of the cutting tool in the left and right direction is less than or equal to 180 mm. In an example, the cutting tool is a handheld cutting tool that can implement grinding or cutting. The length of the cutting tool in the front and rear direction is less than or equal to 350 mm, and the width of the cutting tool in the left and right direction is less than or equal to 160 mm. In an example, the cutting tool is a handheld cutting tool that can implement grinding or cutting. The length of the cutting tool in the front and rear direction is less than or equal to 300 mm, and the width of the cutting tool in the left and right direction is less than or equal to 140 mm.

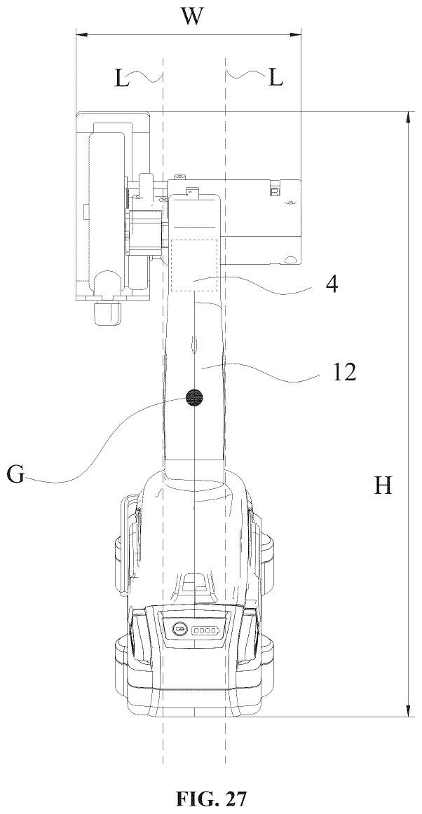

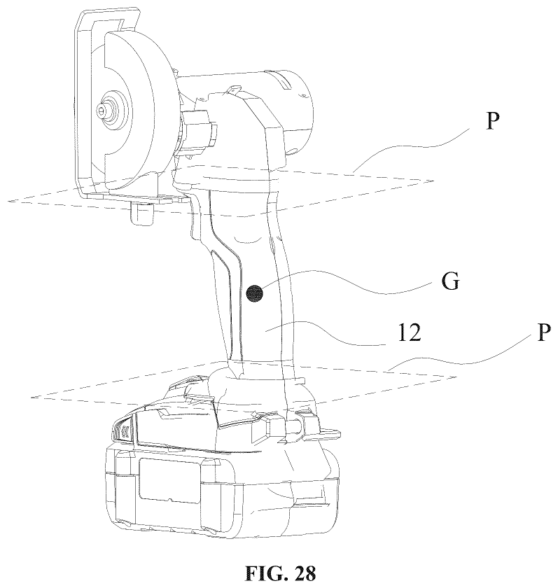

Optionally, as shown in FIG. 27, in this example, the width W of the whole cutting tool in the left and right direction is greater than or equal to 100 mm and less than or equal to 140 mm. The length H of the whole cutting tool in the front and rear direction is greater than or equal to 150 mm and less than or equal to 300 mm. It is to be noted that the length of the whole cutting tool refers to the maximum distance of the cutting tool in a direction parallel to the abutment portion 71, that is, the maximum distance of the cutting tool parallel to a cutting surface. In an example, the length of the cutting tool is about 295 mm and the width of the cutting tool is about 135 mm.

For this handheld cutting tool that is smaller than a traditional circular saw and can be held with a single hand, the grip of the electric motor is disposed between the electric motor and the battery pack. Therefore, this type of cutting tool is relatively small and has limited positions that can be observed and operated by the user. The display mechanism is disposed and an “electroluminescent display” is used as the display mechanism so that a variety of information about the cutting tool can be displayed. In addition, the display mechanism is at least partially disposed at the intersection of the grip and the electric motor housing. Thus, it is convenient for the user to quickly and intuitively obtain the information about the cutting tool in the cutting process. A space utilization rate is greatly increased, and the operation experience of the user is optimized.

Optionally, as shown in FIG. 27, after the battery pack 21 is mounted to the cutting tool, the center of gravity G of the whole cutting tool is at the grip 12 so that the user has better experience when holding the cutting tool. Specifically, the center of gravity G is at the grip 12, which includes the following case: as shown in FIG. 27, from an overhead view, two auxiliary lines L extending along the front and rear direction are made, the two auxiliary lines L are tangent to the left and right ends of the grip 12, respectively, and the center of gravity G is between the two auxiliary lines L. In addition, as shown in FIG. 28, two auxiliary planes P perpendicular to the front and rear direction are made, the two auxiliary planes P are tangent to the two ends of the grip 12 along the front and rear direction one to one, and the center of gravity G is between the two auxiliary planes P.

Optionally, the battery pack 21 may be straight or obliquely inserted into the cutting tool housing 1. The battery pack 21 of the cutting tool shown in FIG. 28 is straight inserted. As shown in FIG. 28, the extension direction of the grip 12 is perpendicular to the rear sidewall of the battery pack 21. The whole cutting tool with the battery pack 21 removed or mounted can be placed vertically. The battery pack 21 of the cutting tool shown in FIG. 1 is obliquely inserted. As shown in FIG. 1, an included angle exists between the extension direction of the grip 12 and the rear sidewall of the battery pack 21.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A cutting tool, comprising:
an electric motor capable of driving a working accessory to rotate;
a cutting tool housing formed with a grip for a user to hold;
a battery pack coupling portion connected to a battery pack for powering the cutting tool;
a control board electrically connected to the electric motor and used to control the electric motor to output a forward rotational movement or a reverse rotational movement; and
a display mechanism comprising a control unit electrically connected to the control board and a display assembly electrically connected to the control unit, wherein the control unit transmits an electrical signal to the display assembly so that the display assembly displays a rotation direction of the electric motor.

2. The cutting tool according to claim 1, wherein the display mechanism further comprises a first function button electrically connected to the control unit, and the first function button is capable of energizing the control unit to cause the display assembly to display the rotation direction of the electric motor.

3. The cutting tool according to claim 2, wherein the rotation direction of the electric motor is further capable of being switched through the first function button.

4. The cutting tool according to claim 3, wherein the first function button comprises a first button and a second button, at least one of the first button and the second button is capable of energizing the control unit, and the first button and the second button are capable of correspondingly switching the rotation direction of the electric motor to forward rotation and reverse rotation, respectively.

5. The cutting tool according to claim 4, wherein the first function button and the display assembly are integrated with each other.

6. The cutting tool according to claim 2, wherein the display mechanism further comprises a second function button electrically connected to the control unit, and the rotation direction of the electric motor is capable of being switched through the second function button.

7. The cutting tool according to claim 1, further comprising a first operation member capable of triggering the control board to be energized and causing the electric motor to rotate.

8. The cutting tool according to claim 7, further comprising a second operation member having a first position, a second position, and a third position, wherein, when the second operation member is at the first position, the whole cutting tool is de-energized, when the second operation member is at the second position, the first operation member is capable of energizing the control board and the control unit, the electric motor rotates forwards, and the display assembly corresponding displays the rotation direction of the electric motor, and, when the second operation member is at the third position, the first operation member is capable of energizing the control board and the control unit, the electric motor rotates reversely, and the display assembly performs corresponding displays the rotation direction of the electric motor.

9. The cutting tool according to claim 8, further comprising a first switch and a second switch, wherein the first operation member is capable of triggering the first switch, the first switch is electrically connected to the control board, the second operation member is capable of triggering the second switch, and the second switch is electrically connected to the control board.

10. The cutting tool according to claim 1, wherein the cutting tool housing is further formed with an electric motor housing connected to the grip, and the electric motor is disposed in the electric motor housing.

11. The cutting tool according to claim 10, wherein the display assembly is at least partially disposed at an intersection of the grip and the electric motor housing.

12. The cutting tool according to claim 1, wherein the cutting tool housing further comprises a battery housing connected to the battery pack for powering the cutting tool, and the display mechanism is connected to the battery housing.

13. The cutting tool according to claim 1, wherein the display assembly comprises one indicator capable of displaying different colors or words.

14. The cutting tool according to claim 1, wherein the display assembly comprises two indicators, and each of the two indicators is capable of indicating one rotation direction of the electric motor.

15. The cutting tool according to claim 1, wherein a length of the cutting tool in a front and rear direction is less than or equal to 400 mm, and a width of the cutting tool in a left and right direction is less than or equal to 180 mm.

16. A cutting tool, comprising:
an electric motor capable of driving a working accessory to rotate;
a battery pack coupling portion connected to a battery pack for powering the cutting tool;
a control board electrically connected to the electric motor and used to control the electric motor to output a forward rotational movement or a reverse rotational movement;
a cutting tool housing formed with a grip for a user to hold, wherein the grip is disposed between the electric motor and the battery pack; and
a display mechanism comprising a control unit electrically connected to the control board and a display assembly electrically connected to the control unit;
wherein the control unit transmits an electrical signal to the display assembly so that the display assembly displays information about the cutting tool, the display mechanism is at least partially disposed at an intersection of the grip and an electric motor housing, and a length of the cutting tool in a front and rear direction is less than or equal to 400 mm, and a width of the cutting tool in a left and right direction is less than or equal to 180 mm.

17. The cutting tool according to claim 16, wherein the display mechanism further comprises a first function button electrically connected to the control unit, the first function button is capable of energizing the control unit to cause the display assembly to display information about the cutting tool, and the first function button is capable of implementing at least one of regulating a speed of the electric motor, turning on and off the cutting tool, turning on and off an illumination assembly, adjusting brightness of the illumination assembly, enabling and disabling a Bluetooth function, switching a working mode, switching a cutting mode, and unlocking and locking the electric motor.

18. A cutting tool, comprising:
an electric motor capable of driving a working accessory to rotate;
a cutting tool housing comprising an electric motor housing and a grip, wherein the electric motor is disposed in the electric motor housing, and the grip is held by a user;
a battery pack coupling portion connected to a battery pack for powering the cutting tool;
a control board electrically connected to the electric motor, wherein after being energized, the control board is capable of controlling the electric motor to output a forward rotational movement or a reverse rotational movement; and
a first function button electrically connected to the control board and capable of switching a rotation direction of the electric motor;
wherein, when operating the first function button to switch the electric motor either from forward rotation to reverse rotation or from reverse rotation to forward rotation, the user applies a force to the first function button in a same direction.

19. The cutting tool according to claim 18, further comprising a display assembly electrically connected to the control board and capable of displaying information about the cutting tool.

20. The cutting tool according to claim 18, wherein a distance between the first function button and the display assembly is greater than or equal to 1 cm.
